(19) United States
(12) Patent Application Publication
(10) Pub. No.: US 2017/0217125 A1
(43) Pub. Date: Aug. 3, 2017

(54) ELECTROSPUN CONDUCTIVE CARBON FIBERS

(71) Applicant: AGENCY FOR SCIENCE, TECHNOLOGY AND RESEARCH, Singapore (SG)

(72) Inventors: Xu LI, Singapore (SG); Suxi WANG, Singapore (SG); Chaobin HE, Singapore (SG); Xikui ZHANG, Singapore (SG)

(21) Appl. No.: 15/510,681

(22) PCT Filed: Sep. 10, 2015
(86) PCT No.: PCT/SG2015/050313

§ 371 Date: Mar. 11, 2017

(30) Foreign Application Priority Data
Sep. 11, 2014 (SG) 10201405662R

(51) Int. Cl. B32B 5/02; D01D 5/00; H01B 1/04; D06N 3/12

(52) U.S. Cl. CPC B32B 5/028; D06N 3/128; D01D 5/0007; H01B 1/04; B32B 2260/021; B32B 2260/048; B32B 2262/106; B32B 2264/105; B32B 2307/202; B32B 2457/00; B32B 2457/20; B32B 2535/00; D06N 2201/087; D06N 2203/022; D06N 2203/066; B32B 2437/00

(57) ABSTRACT

A conductive carbonaceous fiber is provided, comprising a carbonaceous material obtained from carbonizing an electrospun fiber wherein said fiber comprises at least one conductive metal precursor. The electrospun fibers can be formed into fibrous mats during spinning, stabilization and carbonization that are conductive materials which can be used to make stretchable conductors for flexible electronic devices. The invention relates also to the process for making the fibers, corresponding elastomeric fibrous mesh/polymer composites as well as use of these composites for making stretchable electrical conductors. The obtainable elastomeric composite films (with a thickness in the range of 0.8 to 1.5 mm) exhibit good electrical conductivity and excellent electromechanical stability under mechanical deformations (e.g. elongating, twisting and bending). The scalable fabrication process and low-cost precursors make the elastic electrospun carbon fibers/polymer composite conductors promising materials for applications in flexible electronic devices, displays, sensors, wearable conducting clothes, implantable medical devices, etc.

### TECHNICAL FIELD

The present invention generally relates to electrospun carbon fibers and their use as conductive material in carbon fiber/polymer composites. The present invention also relates to stretchable conductors made by a process according to the invention. The present invention therefore relates to the use of these materials in flexible electronic devices, displays, sensors, wearable conducting clothes and implantable medical devices.

### BACKGROUND ART

The creation of flexible electronics is one of the most interesting challenges in material science and engineering nowadays which has the great potential to open up many new exciting applications ranging from wearable electronic clothing, stretchable displays to skin sensors and implantable medical devices. The success of the development strongly relies on the availability of electrically conductive materials capable of substantial elastic stretching, bending, twisting and compressing. In spite of their high conductivity, traditional rigid metal or wafer-based electronic conductors can no longer meet the requirements for flexible electronics, because they cannot retain their conductivity under repeated mechanical deformations. These limitations have motivated intensive efforts to develop conductors that are both conductive and stretchable. One popular strategy developed in recent years is to incorporate metal (such as gold, silver, copper) or silicon-based nanowires or 3D interconnected architectures into elastomeric polymers either by pre-strained elastomeric substrates with conductive materials lying on them or embedding the rigid and active electronic components into a soft rubbery polymer. Although these composite materials exhibit superior conductivity, the fabrication cost of nano-scaled metal/silicon conductive fillers is extremely high. This is a big barrier to produce such stretchable conductors on a large scale.

Very recently, nanostructured carbon materials with good conductivity have also been suggested for the fabrication of conductive stretchable composites with elastic polymers. For example, there were developed black composite films made from single-walled carbon nanotubes (SWCNTs), ionic liquid and fluorinated copolymer as elastomeric conductors with high conductivity when stretched. Transparent elastomeric conductive composites with well-aligned carbon nanotube ribbons were also reported. Others have fabricated elastomeric conductors with high conductivity and stretch ability by infiltrating the interconnected 3D scaffold of poly(methyl methacrylate) (PMMA) coated graphene foam with poly(dimethyl siloxane) (PDMS). However, the cost of carbon nanotubes and graphene fabricated from chemical vapour deposition process is still high. Furthermore, graphene and CNTs phase-segregate or agglomerate within elastomers during dispersion, which hinders practical-scale usage of graphene- or CNT-based elastic conductors. It is therefore desirable to explore inexpensive, green and scalable processes to lower the fabrication cost for industrial applications.

It is known that lignin constitutes a quarter to a third of wood's dry mass, making it the second most abundant polymer in nature after cellulose. It's generally separated from black liquor, a waste discharged from paper mills in large quantities, the disposal of which poses a major problem. On the other hand, as the production of lignin amounts to more than 50 million tons per year, there has been increasing interest in finding new applications for this natural polymer by conversion into useful chemicals and materials. The unique structure of lignin is composed of three-dimensional interconnected phenolic monomers, which makes it the only large-scale biomass source of aromatic functionality. With high carbon contents (above 60%) and molecular structures similar to bituminous coal, this low-cost and renewable feedstock has been used for making carbonaceous materials. But these materials still have limited uses and it would be desirable to make better use of this source of carbon material.

Lignin has been previously utilized as inexpensive feedstock for producing general purpose carbon fibers with size ranging from 20 to 80 μm through conversional melt processes. There have been previously reported low-cost and renewable lignin-derived electrospun carbon nanofibers (with diameters around 500 nm) as high performance electrode materials for energy storage devices, which demonstrate a good electrical conductivity of the obtainable carbon fibrous mats. Electrospinning was used as the method for generating continuous nanofibers from solutions, dispersions or melts of polymers or polymers blends in this technology. However, there are no electrospun lignin-based carbon fiber materials and processes available that would allow a use of such fibers as conductive material in stretched devices.

Current lignin-based fibres or other conductive fillers therefore show no satisfactory performance for being included in stretchable conductors due to stiffness or lack of conductivity under physical stress cycles.

There is still a need to produce stretchable conductors with good electromechanical properties from low-cost, renewable feedstocks through conventional and straightforward fabrication process which could be conducted in a large commercial scale.

Accordingly, there is a need to provide fibers that overcome, or at least ameliorate, one or more of the disadvantages described above and can be used in stretchable conductors.

### SUMMARY OF INVENTION

In a first aspect, there is provided a conductive carbonaceous fiber, comprising a carbonaceous material obtained from carbonizing an electrospun fiber wherein said electrospun fiber comprises at least one metal precursor.

Advantageously, the conductive carbonaceous fibers show good electric conductivity. The metal precursors employed are readily available, low cost manufacturing materials compared to expensive nanoscale metal particles/wires to increase electrical conductivity of the carbonaceous fiber for fabricating hybrid metal/carbon fibrous fillers.

In one embodiment, the fiber is a phenolic fiber that is derived from lignin. Advantageously, lignin is a carbon feedstock from abundant renewable biomass.

In one embodiment, the carbonaceous fibers have a diameter of about 0.1 μm to about 10 μm. These fibers can be spun into meshes which retain the good conductivity even when incorporated into other materials, such as polymer matrices.

Conductive carbonaceous fibers having a diameter of about 0.1 μm to about 10 μm and comprising metallic particles of a size of about 1 nm to about 800 nm, wherein the overall metal content of the fibers is about 5 to 70% by weight are obtained and represent another aspect of the invention.

In a second aspect, there is provided a process for making the fibers according to the first aspect of the invention comprising the steps of a) dispersing the conductive metal precursor into a spinning composition, b) electrospinning of the obtained composition and c) carbonizing the obtained fiber to fully or partially convert the metal precursor to conductive metal nanoparticles.

Advantageously, the addition of metal precursors into the spinning solution during electrospinning and carbonization results in metal nanoparticles in the fiber matrix. The resultant metal nanoparticles are dispersed uniformly in the carbon fibers.

In a third aspect, there is provided a fibrous mesh comprising the fibers according to the first aspect of the invention. Advantageously, the electrospun carbon fibrous mesh with improved conductivity is suitable as electrical conductive filler for stretchable electrical conductors. The electrospun carbon fibrous meshes are easy to handle and do not have the problem of agglomeration when being incorporated into a polymer matrix. In order to further improve the electrical conductivity, highly conductive metals may be introduced uniformly into the carbon fibers simply via incorporation of low-cost metal precursors in the solutions for electrospinning.

Accordingly, in a fourth aspect there is provided a use of a fiber or a mesh according to the invention as conductive filler of a polymer composite.

In a fifth aspect, there is provided a polymer composite material comprising the fibers or the mesh according to the invention together with an elastomer. Advantageously, the composite material exhibits good electrical conductivity (higher than most reported carbon nanotube/PDMS composites) and electromechanical stability under various mechanical deformations. The resultant composites, especially as films, exhibit good electrical conductivity (with sheet resistance less than 1 kΩ/□) and excellent electromechanical stability under various mechanical deformations.

In a sixth aspect there is provided a process for making a fibrous mesh/polymer composite, comprising the steps of a) putting a layer of fibrous mesh on top of a layer of elastomer wherein said elastomer layer is optionally supported by a substrate b) casting a layer of fully or partially uncured elastomer on top of the fibrous mesh optionally supported by degassing in a vacuum; and c) curing the top elastomer layer. Advantageously, this process allows in a simpler and more cost-effective way to make the composites according to the invention when being compared with the known art for making conductive fillers.

In a seventh aspect there is provided a stretchable electrical conductor comprising the fibers, the fibrous mesh, or the fibrous mesh/polymer composite material of the invention. Advantageously, the stretchable electrical conductors comprising the fibers, meshes and composite materials have great potential for a wide range of practical applications including wearable electronic clothing, flexible displays, sensors, implantable medical devices, stretchable circuits and strain gauges.

### Definitions

The following words and terms used herein shall have the meaning indicated:

As used herein, the term “carbonaceous” in connection with fiber(s) or material(s) refers to fiber(s) or material(s) with a high carbon content, which may be greater than about 70 weight percent of the fibers or materials, not including the metal particles. The carbon content may be increased as a result of an irreversible chemical reaction of a carbonaceous fiber precursor, such as the phenolic fiber, for example by heat treatment, to render the fibers carbonaceous. The carbonaceous fibers may be substantially produced from polymeric precursor fibers, such as phenolic fibers, polyacrylonitrile fibers, polypyrrole fibers, polystyrene fibers, polymethylacrylonitrile fibers, polyaromatic hydrocarbon fibers, biomass-derived polymer fibers or fibers made from a combination of such materials.

As used herein, the term “conductive” in connection with fiber(s) or material(s) refers to the ability of the fiber or material to conduct an electric current.

As used herein, the term “carbonaceous fiber precursor” refers to polymeric precursor fibers that are capable of undergoing an irreversible chemical reaction, for example, heat treatment, to produce carbonaceous fibers. One example of polymeric precursor fibers are phenolic fibers. Other examples are polyacrylonitrile fibers, polypyrrole fibers, polystyrene fibers, polymethylacrylonitrile fibers, polyaromatic hydrocarbon fibers, biomass-derived polymer fibers or fibers made from a combination of such materials.

As used herein, the term “fibers” refers to fibers prepared by electrospinning precursor materials, wherein the precursor material is a carbonaceous fiber precursor.

As used herein, the term “phenolic polymer” refers to a polymer comprising phenolic monomers. The phenolic polymer may be derived from lignin.

As used herein, the term “polyacrylonitrile” refers to a polymer comprising acrylonitrile monomers.

As used herein, the term “polypyrrole” refers to a polymer comprising pyrrole monomers.

As used herein, the term “polystyrene” refers to a polymer comprising styrene monomers.

As used herein, the term “polymethylacrylonitrile” refers to a polymer comprising methylacrylonitrile monomers.

As used herein, the term “biomass-derived polymer” refers to a polymer substantially made from biological material derived from living, or recently living organisms as the main component.

As used herein the term “metal precursor” refers to a precursor of metal or metal oxide nanoparticles (NPs). The metallic nanoparticle is obtained in the process of electrospinning polymer nanofibers and their carbonization wherein the electrospinning polymer may act as a reduction agent for the metal precursor after conversion or decomposition, as well as a protecting or templating agent for the ensuing metal nanoparticles.

As used herein, the term “lignin” refers to any lignin or lignin derivative which include Brauns' lignin, cellulolytic enzyme lignin, dioxane acidolysis lignin, milled wood lignin, Klason lignin, periodate lignin, kraft lignin, softwood kraft lignin, hardwood kraft lignin, lignosulfates, lignosulfonates, organosolv lignin, and steam explosion lignin or any substances made in whole or in part from lignin or any subunits, monomers, or other components derived therefrom. Thus, lignin is meant to include lignin, and/or any compound comprising lignin or the residue thereof and refers to any polymer comprising p-hydroxyphenyl units, syringyl units, and guaiacyl units.

Structurally lignin is a cross-linked racemic macromolecule with molecular masses in excess of about 10,000 units. It is relatively hydrophobic and aromatic in nature. Lignin may be derived from the support tissues of vascular plants and some algae. It is a phenolic polymer. The degree of polymerisation in nature is difficult to measure, since it is fragmented during extraction and the molecule consists of various types of substructures that appear to repeat in a haphazard manner. Different types of lignin have been described depending on the means of isolation. There are three monolignol monomers, methoxylated to various degrees: p-coumaryl alcohol, coniferyl alcohol, and sinapyl alcohol. A typical example of a lignin structure is shown in FIG. 1.

As used herein, if not otherwise defined, the term “nano” is to be interpreted broadly to include dimensions less than about 1000 nm.

As used herein, the term “elastomer” refers to a polymer with viscoelasticity (having both viscosity and elasticity). The elastomer may be chosen from unsaturated rubbers, such as for instance natural polyisoprenes (e.g. cis-1,4-polyisoprene natural rubber (NR) and trans-1,4-polyisoprene gutta-percha), synthetic polyisoprene (IR), Polybutadiene (BR), chloropene rubber (CR), butyl rubber (e.g. copolymer of isobutylene and isoprene, IIR), halogenated butyl rubbers (e.g. chloro butyl rubber (CIIR); bromo butyl rubber: (BIIR), styrene-butadiene Rubber (copolymer of styrene and butadiene, SBR), nitrile rubber (e.g. copolymer of butadiene and acrylonitrile (NBR), hydrogenated Nitrile Rubbers (HNBR), or from saturated rubbers, such as for instance EPM (ethylene propylene rubber, a copolymer of ethylene and propylene) and EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone Rubber (FVMQ), fluoroelastomers (FKM, and FEPM) (e.g. Viton, Tecnoflon, Fluorel, Aflas and Dai-E1), perfluoroelastomers (FFKM) (e.g. Tecnoflon PFR, Kalrez, Chemraz, Perlast), polyether block amides (PEBA), chlorosulfonated polyethylene (CSM), (e.g. Hypalon) or ethylene-vinyl acetate (EVA). According to this invention silicone rubber (such as polysiloxanes or polydimethylsiloxanes) may be a preferred elastomer (rubber-like material) composed of silicone containing silicon together with carbon, hydrogen, and oxygen. The elastomer may be also chosen from polyurethanes. The polyurethane may be a flexible polyurethane foam.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and sub-generic groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of the carbonaceous fibers will now be disclosed.

There is provided a conductive carbonaceous fiber, comprising a carbonaceous material obtained from carbonizing an electrospun fiber wherein said electrospun fiber comprises at least one metal precursor before carbonization.

The electrospun fiber can be derived from various polymers, polyaromatic hydrocarbons or combinations thereof. As such polymers there can be mentioned: phenolic polymers, polyacrylonitrile s, polypyrrole s, polystyrenes, polymethylacrylonitriles, biomass-derived polymers and any combination thereof. Combinations of the polymers or hydrocarbons may be mixtures or co-polymers. These polymers and their combinations are the basic fiber materials. As a preferred basic fiber material phenolic fibers may be used. The electrospun fiber may then be a phenolic fiber. The phenolic fiber may be derived from a biomass-derived polymer, such as for instance lignin.

At least one metal precursor used in the present invention may convert substantially to the corresponding metal in a conversion process during the thermal curing of the carbonizable electrospun fiber. Under preferred conditions metallic nanoparticles may be formed in the course of this conversion and carbonization process, wherein said metallic nanoparticles preferably have an average particle size in the range of about 1 nm to about 800 nm, more preferably in the range of about 20 nm to about 200 nm and particularly preferably in the range of about 2 nm to about 100 nm or of about 2 nm to about 40 nm.

It is preferred that metallic nanoparticles are formed during the conversion process from the metal precursors of the present invention. The size and distribution of the formed metallic particles, such as metallic nanoparticles, can be controlled by the chemical nature of the used metal precursor. The metallic particles may comprise metal oxides that have been formed as an intermediate by oxidation during the stabilization or may be metals.

The metal precursor can be any metal compound. It may be a compound that can be converted to a conductive metal. It may be a metal compound that can be converted to metal or metal oxide nanoparticles in electrospun fibers. The term “metal compound”, as used herein, preferably refers to metal salts, and/or metal organic compounds that can be metal precursors for metals or metal oxides in in the fiber matrix under thermal stabilization and conversion.

The metal in the metal compound may comprise any metal, such as Au, Cu, Ni, Ca, Pd, Pt, Ti, V, Mn, Fe, Cr, Zr, Nb, Mo, W, Ru, Cd, Ta, Re, Os, Ir, Al, Ga, Ge, In, Sn, Sb, Pb, Bi, Si, As, Hg, Sm, Eu, Th, Mg, Ca, Sr and/or Ba. Preferably it is a metal with good conductivity, such as for instance Ag, Au, Cu, Ni, Al, Mo, Zn, Pt, Pd, Fe, Ti, Hg or Pb. Most preferably it is selected from Cu, Ni. Fe, Pt or Ag.

The metal compound may be selected from metal oxides, metal acetates, metal halogenides, metal cyanides, metal cyanates, metal carbonates, metal nitrates, metal nitrites, metal sulfates, metal sulfites, metal sulfides, metal phosphates, metal thiocyanates, metal chlorates, metal perchlorates, metal borates, metal fluoroborates, metal amides, metal alkoxides, metal acetylacetonates, metal carboxylates and/or mixtures or combinations thereof.

In one embodiment the metal compound used in the fabrication of the metal precursors of the present invention is a copper, silver, iron, platinum or nickel salt. The salt may be copper acetate, copper nitrate, copper chloride, nickel acetate or nickel nitrate.

The fiber is obtained by electrospinning, preferably from a solution. Such a method is well-known and for instance described in J. H. Wendorff et al., Angew. Chem Int. Ed. 2007, 46, 5670-5703.

In one embodiment the fiber is derived from lignin. The lignin may be selected from the group consisting of organosolv lignin, softwood kraft lignin, hardwood kraft lignin and lignosulfonate or other lignin sources from common technical processes.

In one embodiment the metal precursor partly or fully converts to a corresponding conductive metal nanoparticle via pre-oxidation and reduction during a stabilization and carbonization process.

The carbonaceous fibers may have a thickness in the range of about 0.1 to 10 μm, or about 0.2 to 8 μm, or about 0.3 to 7 μm, or about 0.3 to 5 μm, or about 0.3 to 3 μm, or about 0.3 to 2 μm, or about 0.3 to 1 μm, or preferably about 300 to 700 nm, or most preferably about 400 to 600 nm.

Metal content of the fibers after carbonization may be about 5 to 70% by weight. The metal content may be about 10 to 50% by weight, or about 10 to 30% by weight, or about 20 to 70% by weight, or about 20 to 50% by weight, or about 20 to 40% by weight.

The obtained fibers of carbonized material are therefore conductive carbonaceous fibers having a diameter of about 0.1 μm to about 10 μm and comprising metallic particles of a size of about 1 nm to about 800 nm, wherein the overall metal content of the fibers is about 5 to 70% by weight. These fibers are another aspect of the invention. The carbonized material may be an elctrospun fibers as described above, preferably comprising the metal precursor as described above.

In a second aspect, there is provided a process for making the fibers according to the first aspect of the invention comprising the steps of a) dispersing the conductive metal precursor into a spinning composition, b) electrospinning of the obtained composition and c) carbonizing the obtained fiber to fully or partially convert the metal precursor to conductive metal nanoparticles.

The spinning composition comprises a polymer, polyaromatic hydrocarbon or combinations thereof. The spinning solution may optionally contain additional additives together with a solvent. The spinning solution may comprise a phenolic polymer as main component.

In one embodiment, the spinning composition may be a solution of the components in a polar solvent. The polar solvent refers to a solvent wherein the solvent molecules have an uneven distribution of electron density. Examples of polar solvents are water, water-miscible organic solvents, or mixtures thereof such as acetone, acetonitrile, N,N-dimethylformamide (DMF), tetrahydrofuran (THF), ethyl acetate (EtOAc), formamide, dimethyl sulfoxide (DMSO), acetamide, water, ethanol, methanol, ethanol, isopropanol, n-propanol, ethylene glycol, triethylene glycol, glycerol, polyethylene glycol, propylene glycol, dipropylene glycol, polypropylene glycol, random and block copolymers of ethylene oxide and propylene oxide, dimethoxytetraglycol, butoxytriglycol, trimethylene glycol trimethyl ether, ethylene glycol dimethyl ether, ethylene glycol monobutyl ether, ethylene glycol monoethyl ether, and mixtures thereof, but are not limited thereto. DMF may be preferred.

In another embodiment, the addition of an additional polymer may greatly improve the viscosity and spinnability of the polymer solution during electrospinning The additional polymer may be selected from copolymers of acrylate and methacrylate, copolymers of ethylene oxide and propylene oxide, homo-polyethers, co-polyethers, homo-polyesters, co-polyesters, co-polyether-polyesters, and polymer blends thereof The homo- or co-polyether may be selected from the group consisting of homo-(polyalkylene oxide), co-(polyalkylene oxide) and poloxamer. The homo- or co-polyether may be selected from the group consisting of homo-(polylactone), co-(polylactone), homo-(polyhydroxyalkanoate) or co-(polyhydroxyalkanoate). In one embodiment, the additional polymer may be polyethylene glycol, polyethylene oxide, polypropylene glycol, polypropylene oxide, polycaprolactone, polyhydroxybutyrate, poloxamer 407, or pluronic F127. The molecular weight of the additional polymer may be from about 100,000 to about 1,000,000, or about 100,000 to about 900,000, or about 100,000 to about 800,000, or about 100,000 to about 700,000, or about 100,000 to about 600,000, or about 100,000 to about 500,000, or about 100,000 to about 400,000, or about 100,000 to about 300,000, or about 100,000 to about 200,000, or about polyethylene oxide (PEO) is especially preferred as the additional polymer.

The weight ratio of the basic fiber material, such as for instance the phenolic polymer, to the additional polymer may be tuned. In one embodiment, the weight ratio of the basic fiber material, such as for instance the phenolic polymer, to the additional polymer may be from about 80 to 99 weight percent of basic fiber material to about 1 to 20 weight percent of the additional polymer. The weight ratio of basic fiber material to the additional polymer may be from about 85 to 99 weight percent of basic fiber material to about 1 to 15 weight percent of the additional polymer, 90 to 99 weight percent of basic fiber material to about 1 to 10 weight percent of the additional polymer, 95 to 99 weight percent of basic fiber material to about 1 to 5 weight percent of the additional polymer. The weight ratio may be 97 weight percent of basic fiber material to 3 percent of the additional polymer. The weight ratio may be 90 percent weight percent of basic fiber material to about 10 weight percent of the additional polymer. In case that a phenolic polymer derived from lignin is used as basic fiber material, a weight ratio of lignin to PEO can be tuned from 99:1 to 90:10 via varying the concentration of the polymer solutions from 40 to 20% by weight.

Alternatively the spinning composition may be a melt or dispersion of the components.

In one embodiment, the fiber may be derived from lignin. The lignin may be selected from the group consisting of: organosols lignin, softwood kraft lignin, hardwood kraft lignin and lignosulfonate or other lignin materials from known technical processes.

In step a) the metal precursor is dispersed into the spinning composition. The weight ratio of metal precursor to the basic fiber material may be about 5 to 70% weight percent. Preferably, the weight ratio of metal precursor to basic fiber material may be tuned. The weight ratio of metal precursor to basic fiber material may be about 50 to 60 weight percent of metal precursor to about 40 to 50 weight percent of the basic fiber material. The weight ratio of metal precursor to basic fiber material may be from about 55 to 65 weight percent of metal precursor to about 35 to 45 weight percent of basic fiber material, 45 to 55 weight percent of metal precursor to about 45 to 35 weight percent of basic fiber material, 35 to 45 weight percent of metal precursor to about 55 to 65 weight percent of basic fiber material. The basic fiber material may preferably be a phenolic polymer

Step a) is preferably performed under stirring and at elevated temperature.

Step b) is performed by known methods of electrospinning of a solution/dispersion which use an electrical charge to draw very fine (typically on the micro or nano scale) fibres from a liquid to form a nano fiber. The fibers may be sprayed on substrate with an applied voltage of 5 to 10 kV. The feed rate can be varied widely, but may be generally 0.5 to 10 mL per minute. A needle tip-to-plate substrate distance can be varied, but a distance of about 0.5 to 20 cm may be mentioned. Preferably the obtained nanofibers are dried at elevated temperatures of about 50 to 100° C. under vacuum or other exclusion of air after being electrospun.

Step c) is a carbonization step. The carbonization step may be undertaken in an inert atmosphere, preferably in argon. During carbonization the carbonaceous fibers may be heated to above 700° C., preferably to 750 about 1000° C., or from about 800° C. to about 950° C., or from about 850° C. to about 950° C. Most preferably, the carbonaceous fibers may be heated from about 875° C. to about 1000° C.

In order to make the metal carbonaceous fibers, the temperature during carbonization must be chosen in a way that the metal precursor can at least partly convert and be reduced by the carbon of the fiber environment to the metal. Temperatures between 850 and 950° C. may be preferred.

In another embodiment, stabilization, optionally supported by annealing, may be utilized as a pre-step of the carbonization. In the pre-step the metal precursor may be converted to a metal oxide in a pre-oxidation. For instance a first stabilization step may be used to heat up the electrospun fiber to about 25° C. to 500° C., or from about 40° C. to about 400° C., or from about 60° C. to about 350° C., or from about 120° C. to about 300° C., or from about 175° C. to about 250° C. in air. During this step metal oxides may be formed after conversion of the metal precursor which may be reduced to metal in the following higher temperature carbonization step. A temperature ramping at lower temperate in air and then higher temperature under inert gas flow can be used as annealing in the combined stabilization and carbonization step c) of another embodiment.

In a third aspect, there is provided a fibrous mesh comprising the fibers according to the first aspect of the invention. The fibres can be spun directly into a mesh form during step a) and cured in step b). The meshes may be in various shapes. A mesh in the form of a mat may be preferred to make flat conductive composites therefrom.

In a fourth aspect, there is provided a use of a fiber or a mesh according to the invention as a conductive filler of a polymer composite. The polymer composites may comprise the carbonaceous fibers according to the first aspect of the invention and other polymers.

Polymer composites made with the fibers according to the invention may be flexible or can be stretched.

In a fifth aspect, there is provided a polymer composite material comprising the fibers or the mesh according to the invention together with an elastomer. The composite material may comprise the fibers or meshes as conductive fillers within the elastomer matrix. The fibres may be used as an integral part within the elastomer matrix. In one embodiment the polymer composite material comprises an elastomer that is selected from one or more polysiloxanes, polyurethanes, rubbers or a combination thereof. Polysiloxanes may be preferably used.

The weight ration of fibers or the mesh to the elastomer may be less than about 1 weight percent. Generally it may be for instance about 0.01 to 5 weight percent, or about 0.05 to 2 weight percent, or about 0.1 to 1 weight percent.

In one embodiment the composite material comprises a mesh according to the invention and forms a fibrous mesh/polymer composite material. The mesh may then be integrated into an elastomer matrix. In this case, especially if the mesh is in form of a mat, the mesh may be formed to a layer in the fibrous mesh/polymer composite material. This layer may be integrated into an elastomer layer resulting in an integrated composite layer. The integration can be in different forms: For instance the mesh layer can be in between elastomer layers. The mesh layer can also be inside the elastomer layer matrix.

Such fibrous mesh/polymer composite material may contain an integrated layer of polysiloxane/mesh of various thicknesses. The thickness of the integrated composite layer (combined layer of mesh and elastomer) may be about 0.1 to 20 mm, or about 0.5 to 10 mm or about 0.6 to 3 mm.

In another embodiment, the elastomer layer with the integrated mesh in the fibrous mesh/polymer composite material is supported by another substrate. The integrated mesh/elastomer layer may be on top of a support substrate layer. The substrate can be rigid or flexible itself.

In a sixth aspect there is provided a process for making the fibrous mesh/polymer composite, comprising the steps of a) putting a layer of fibrous mesh on top of a layer of elastomer wherein said elastomer layer is optionally supported by a substrate; b) casting a layer of fully or partially uncured elastomer on top of the fibrous mesh optionally supported by degassing in a vacuum and c) curing the top elastomer layer.

In step a) a layer of fibrous mesh is put on top of the elastomer layer. The fibrous mesh may be in form of a mat that is laid on a pre-casted, partially or fully cured elastomer layer. The pre-casted, partially or fully cured elastomer layer may be created in a pre-step by curing an elastomer on top of a substrate, such as for instance a glass or polycarbonate plate. The elastomer may be a polysiloxane, polyurethane or rubber partially or fully pre-cured on a substrate by using a silicone-elastomer curing agent as known in the art. Polydimethylsiloxane (PDMS) and its derivatives as well as siloxane mixtures comprising PDMS may be especially mentioned. The thickness of the pre-casted film (e.g. a PDMS film) may be about 0.05 to 10 mm, or about 0.3 to 5 mm or about 0.3 to 0.8 mm.

In one embodiment the elastomer is pre-stretched in step a) when the mesh is put on top of the elastomer layer. A strain of about more than 5%, preferably 5 to 50%, most preferable 20 to 40% is used.

In step b) a layer of not fully cured elastomer is casted on top of the optionally pre-stretched first elastomer layer with the laid mesh. To ensure good integration of the mesh into the elastomer polymer matrix, it may be advantageous to degas the uncured top layer, for instance by applying a vacuum.

In step c) the top layer will be cured by known methods of curing the elastomer. Uncured polysiloxane elastomers, for instance, can be cured thermally at elevated temperatures, such as for instance about 50 to 200° C., preferably 60 to 90° C. Curing times may be about 0.5 to 5 hours.

After step c) the finally made fibrous mesh/polymer composite may be peeled off from the supporting substrate, in case that such support is used. The resulting fibrous mesh/polymer composite may be pre-curved for further use.

In a seventh aspect there is provided a stretchable electrical conductor comprising the fibers, the fibrous mesh, or the fibrous mesh/polymer composite material of the invention. Such stretchable electrical conductor may be for instance an electronic device, a display, a sensor, smart wearable conducting clothes, an implantable medical device. In the stretchable electric conductor the fibers can be stretched and still remain conductive. The stretching can be by elongation, compressing, bending or twisting which is tolerated. The stretchable electrical conductor comprising the fibers may be used over more than 20 stretching cycles without decreasing their conductivity. Strain applied may be between 10 and 80%, preferably 30 and 70%.

### BRIEF DESCRIPTION OF DRAWINGS

The accompanying drawings illustrate a disclosed embodiment and serve to explain the principles of the disclosed embodiment. It is to be understood, however, that the drawings are designed for purposes of illustration only, and not as a definition or the limitation of the invention.

FIG. 1 shows the fabrication process of electrospun carbon fibrous mats from lignin.

FIG. 2a shows an SEM image of a lignin-derived copper/carbon nanofiber.

FIG. 2b shows an SEM image of a lignin-derived copper/carbon nanofiber.

FIG. 2c shows a cross-sectional TEM image of the copper/carbon nanofibers.

FIG. 3a shows an XRD spectrum of the lignin-derived electrospun copper/carbon nanofibers.

FIG. 3b shows a Raman spectra of the lignin-derived electrospun carbon nanofibers with and without copper.

FIG. 4 shows the fabrication process of electrospun carbon fibrous mat/PDMS composites.

FIG. 5a shows a photograph of the PDMS composite film embedded with electrospun carbon fibrous mat.

FIG. 5b shows a cross-sectional SEM image of the electrospun carbon fiber/PDMS composite before stretch-release test.

FIG. 5c shows cross-sectional SEM image of the electrospun carbon fiber/PDMS composite after stretch-release test.

FIG. 6 shows typical stress-strain curves of PDMS and electrospun copper/carbon fiber/PDMS composites with 0.7 wt % carbon fiber loading.

FIG. 7 shows the sheet resistance vs. strain of electrospun carbon fiber/PDMS composite films with or without copper.

FIG. 8a shows the sample shape induced by bending and twisting.

FIG. 8b shows the sample shape induced by bending and twisting.

FIG. 8c shows the dependence of normalized resistance (R/R₀) on the number of bending (with a bending radius of 4 mm) and twisting cycles.

FIG. 9a shows the sample shape induced by stretching and releasing.

FIG. 9b shows the sample shape induced by stretching and releasing.

FIG. 9c shows the dependence of normalized resistance (R/R₀) on the number of stretching and releasing cycles with different maximum applied strain (20%, 40% and 60%).

### DETAILED DESCRIPTION OF DRAWINGS

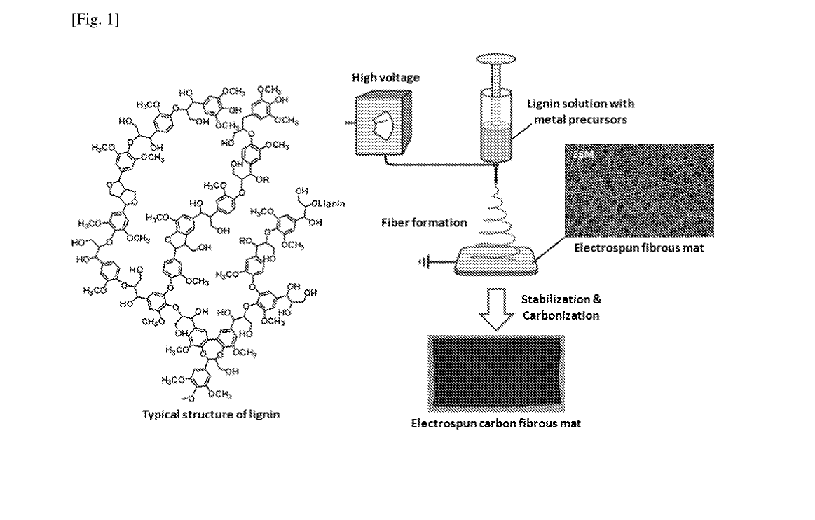

Referring to FIG. 1, it is shown that the disclosed lignin-derived hybrid carbon nanofibers are fabricated via electrospinning the lignin/DMF solutions incorporated with metal precursors (such as for instance copper acetate, copper chloride, nickle nitrate, etc.) followed by thermal stabilization and subsequent carbonization.

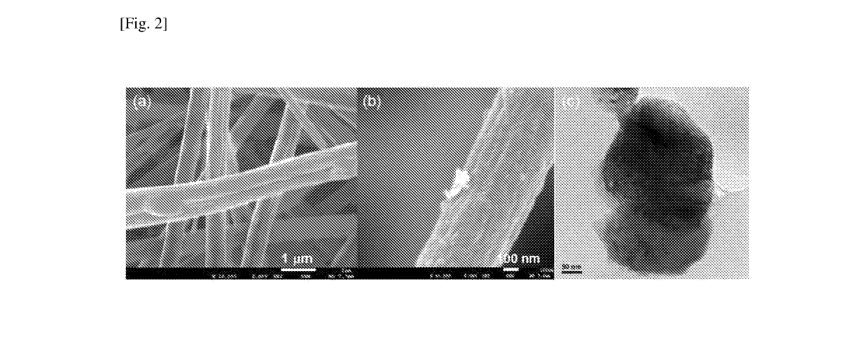

Referring to FIGS. 2a, b and c, the FIGS. 2a and b present the typical SEM images of the electrospun copper/carbon nanofibers derived from lignin and copper acetate with diameters around 500 nm. The surface of the fibers is not smooth because of the loading of metals. The cross-sectional TEM image (FIG. 2c) reveals the uniform dispersion of copper in the resultant carbon fibers.

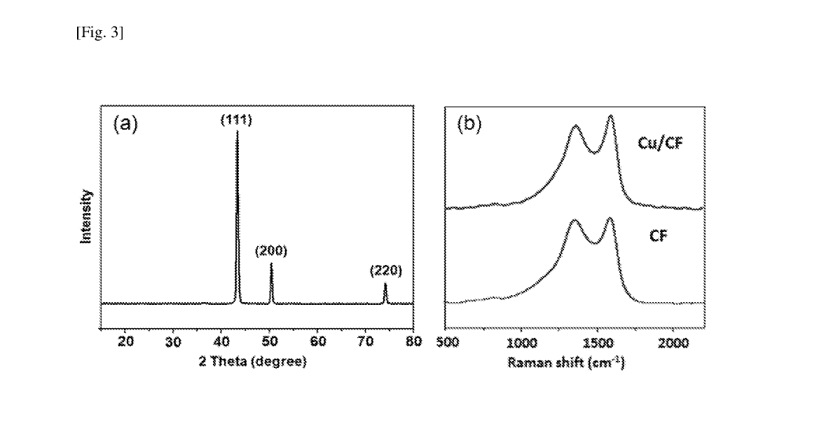

Referring to FIG. 3, FIG. 3a gives evidence for the uniform dispersion of copper in the resultant carbon fibers by their X-ray diffraction (XRD) spectrum which shows very pure copper diffraction peaks at 43.3, 50.4 and 74.1°. The uniformly embedded metal nanoparticles (such as copper, nickle, etc.) not only improve the electrical conductivity of the fibers, but also act as catalyst to generate higher degree of graphitization of the lignin-derived carbon. The Raman spectra of the lignin-derived electrospun carbon fibers with and without copper are shown in FIG. 3b. The peak intensity ratio of D band (1350 cm⁻¹, disordered carbon) to G-band (1580 cm⁻¹, sp² carbon) decreased from 1.79 to 1.34 after incorporation of 40 wt % copper, indicating that larger proportions of graphitic carbon is formed under the catalysis of copper. The electrical conductivity of the lignin-derived pure electrospun carbon fibrous mats is 287 S/m, which could be enhanced to 1024 S/m after loading with 40 wt % copper.

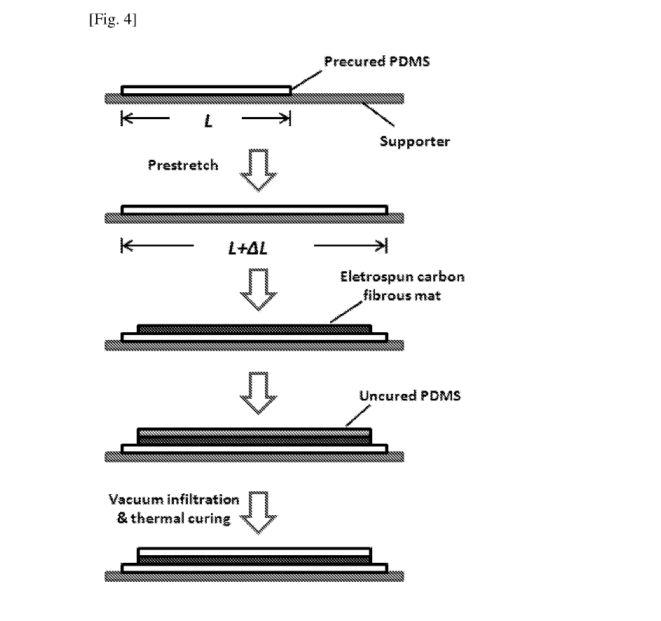

Referring to FIG. 4, the schematic fabrication process of the PDMS composites incorporated with electrospun carbon fibrous mats is shown. First, the electrospun hybrid carbon fibrous mats were laid on the surface of a pre-stretched PDMS film with a length of L+ΔL. Then a thin layer of uncured PDMS was cast on top of the carbon fiber, followed by vacuum infiltration at room temperature for 0.5 h and thermal curing at 70° C. in the air for 1 h.

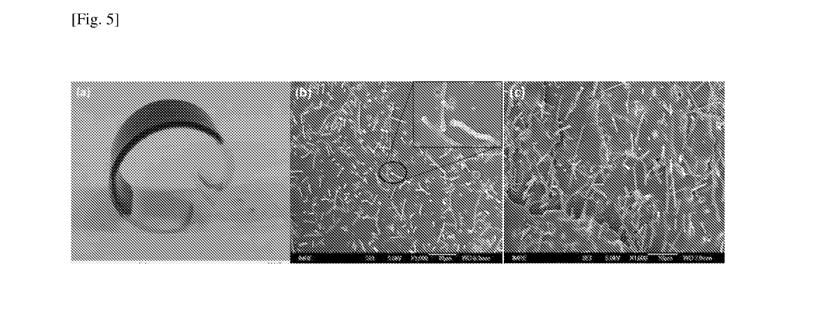

Referring to FIG. 5, it is shown that the composite film was finally peeled off and exhibited a curved shape (as shown in FIG. 5a) because there is stain on one side of the film. It can be mentioned that the interaction between the carbon fibers and PDMS was so strong that no obvious defects were observed in the cross-sectional SEM image of the composite (FIG. 5b). Incorporation of PDMS matrix does not damage the scaffold of the carbon fibrous mats, because the electrical conductivity of the carbon fibers showed nearly no change after infiltration with PDMS. The thickness of the resulting film was in the range of 0.8 to 1.5 mm with a weight ratio of carbon fiber less than 1 wt %. The composite films exhibit good flexibility, and can be bent, stretched and twisted without breaking.

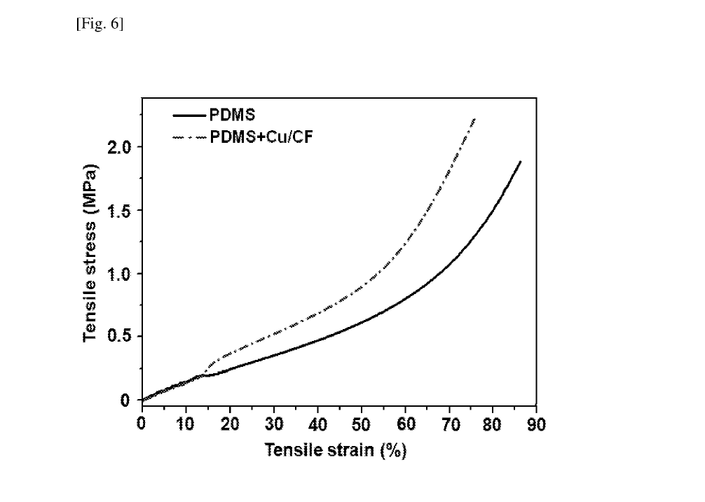

Referring to FIG. 6, it is shown that incorporation of the electrospun carbon fibers obviously improves the mechanical properties of the PDMS matrix, as revealed in the stress-strain curves shown in FIG. 6. The ultimate strength of the carbon fiber/PDMS composites with a pre-stretched length of 30% is increased by a factor of 1.25 compared with the pure PDMS films.

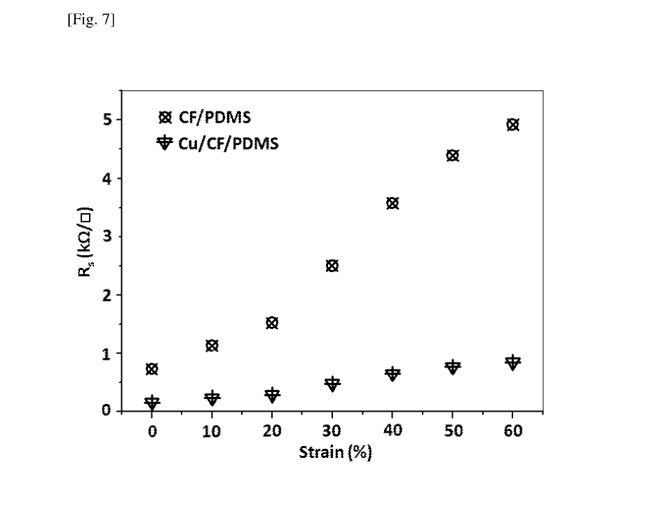

Referring to FIG. 7, it is shown that the electrical sheet resistance of the composite films as a function of applied tensile strain from 0 to 60%. The initial sheet resistance of the composite with copper/carbon fibers (40 wt % loading of copper) was as low as 0.16 kΩ/□ which increased slowly with the increase of tensile stain. When the film was stretched to 60% longer and released, the sheet resistance still kept at a low level around 0.85 kΩ/□ (increased by 4 times). The value is much lower than most reported CNT/PDMS composites. The increase in sheet resistance is mainly due to less local interconnections or decreased contact area between adjacent carbon fibers after stretching to a certain degree. As a comparison, PDMS composite films with pure electrospun carbon fibers were also fabricated. However, they exhibited much higher sheet resistance from 0.73 to 4.92 kΩ/□ with 0 to 60% applied tensile strain. In order to investigate the reversibility of this conductor, repetitive mechanical deformation cycles were applied.

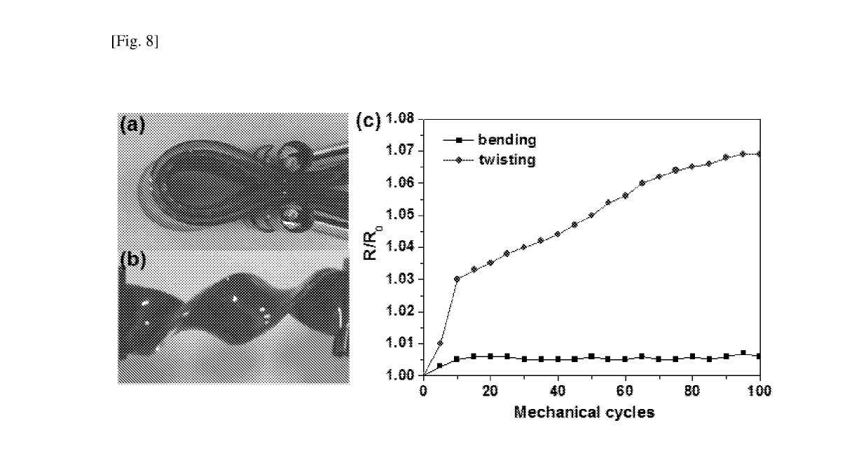

Referring to FIG. 8, the dependence of normalized resistance (R/R₀) on the number of bending (with a bending radius of 4 mm) and twisting cycles is shown. It was found that the electrical conductivity of the composite sheets revealed little sensitivity to repeated bending and the change of resistance under 100 cycles of twisting deformations is less than 7%.

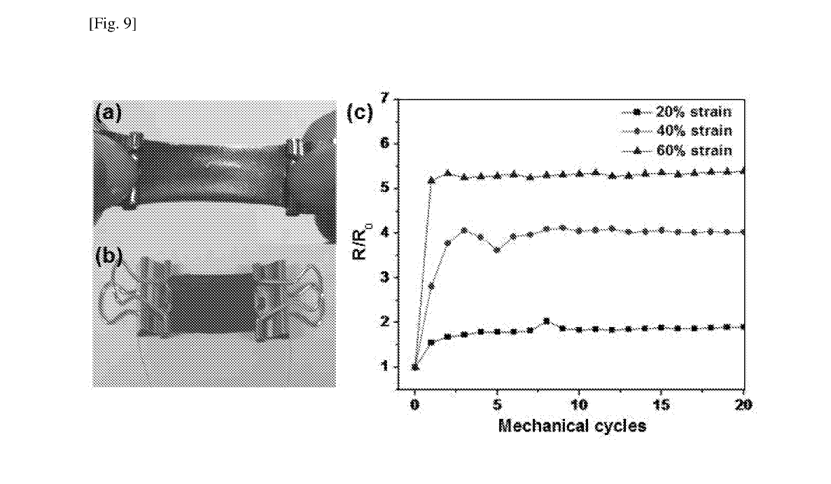

Referring to FIG. 9, the variations of the normalized resistance of the composites as a function of tensile strain up to 60% in the first twenty stretch-release cycles are presented. It can be seen that that the resistance change of the composite sheets quickly stabilizes after the first 5 elongation-contraction cycles. After such initial conditioning, the resistance remains almost constant for various tensile strains (20%, 40% and 60%). FIG. 5c additionally shows the cross-sectional image of the composite after repeated stretch-release test. The interconnection of the carbon fibers within the polymer matrix exhibits an accordion phenomenon. The fibers break when stretched and connected with one another again upon release, leading to good stability of their electrical conductivity. Due to the good electromechanical properties, inexpensive precursors and easy fabrication, the lignin-derived electrospun hybrid carbon fiber/PDMS composites can be produced in large scale and applied in flexible, stretchable and foldable electronics

### EXAMPLES

Non-limiting examples of the invention and a comparative example will be further described in greater detail, which should not be construed as in any way limiting the scope of the invention.

### Example 1

### Preparation of Electrospun Copper/Carbon Fibrous Mats from Lignin

436 mg Alcell lignin and 48 mg polyethylene oxide (Mw 600K) were dispersed into 2 mL N,N-dimethylformamide (DMF) under magnetic stirring and the suspension was heated at 60° C. for 0.5 hours. Then 545 mg copper acetate monohydrate was added to the mixture and stirring was continued at 60° C. for 1 hour. After cooling down to room temperature naturally under continuous stirring, the solution was placed in a 1 mL plastic syringe fitted with a flap tip 22 G needle and was electrospun using a horizontal electrospinning setup with air humidity lower than 40%. Electrospinning of the above suspensions was carried out using a conventional single-spinneret electrospinning setup (model: nanon-01A of MECC Co., Ltd., Japan). Typically, electrospinning was performed at 7.5 to 8.5 kV with a feeding rate of 1.5 mL/h and the needle tip-to-plate substrate distance was 10 cm. The nanofibers were collected on aluminium foil and dried at 70° C. under vacuum overnight. The dried nanofibers were thermostabilized in a tube furnace under atmospheric environment. The temperature was ramped from 25 to 200° C. at 1° C. min⁻¹ and kept at 200° C. for 2 hours. The stabilized fibers were then heated from 200 to 900° C. at 10° C. min⁻¹ under a flow of argon (150 cm³ STP/min) and carbonized at 900° C. for 3 hours.

### Example 2

### Preparation of PDMS Substrate

The PDMS substrate was prepared by mixing a silicone-elastomer base and curing agent (Sylgard 184, Dow Corning) at a ratio of 10:1 by weight. The mixture was first degassed under stirring in vacuum for 1 hour and then poured onto a glass substrate, followed by curing at 70° C. in the air for 1 h. The thickness of the resulting film was in the range of 0.4-0.6 mm.

### Example 3

### Preparation of Electrospun Carbon Fiber/PDMS Composites

The electrospun carbon fibrous mats were laid on a PDMS substrate pre-stretched with a strain of 30%. Then a thin layer of uncured PDMS was cast on top of the carbon fiber, followed by degassing in a vacuum oven at room temperature for 0.5 h and thermal curing at 70° C. in the air for 1 h. The thickness of the resulting film was in the range of 0.8 to 1.5 mm.

### Example 4

### Characterization

The electrical conductivity of the electrospun carbon fiber/PDMS composites was measured by a two-probe digital multimeter at room temperature. Thin copper wires were embedded and connected to the carbon fibrous mats with electronically conductive silver paint (RS 186-3593, RS Components Ltd, UK) before infiltration with PDMS pre-polymer. The mechanical strength of the carbon fiber/PDMS composite films were measured with an Instron 5569 universal testing machine equipped with 500 N loading cells. The stain ramp rate was maintained at 10 mm per minute for all the tests.

Morphology of the carbon nanofibers were observed under JEOL JSM 6700 field-emission scanning electron microscope at an accelerating voltage of 5 kV. All samples were coated with a thin gold layer before SEM imaging. To observe the cross-sectional morphology, the copper/carbon fibrous mats were embedded into epoxy and cut into 50 nm slices using a microtome (Leica) before attaching onto copper grids. High resolution TEM images were obtained with a JEOL 2100 transmission electron microscope. Wide-angle X-ray diffraction (XRD) measurements were performed using a Bruker D8 Discover GADDS X-ray diffraction meter with Cu Ka radiation and Raman spectra were recorded on Jobin Yvon T64000 triple spectrograph micro-Raman system. The metal content in the resultant hybrid carbon fibers was measured by inductively coupled plasma mass spectrometry (ICP-MS) analysis.

### INDUSTRIAL APPLICABILITY

The fibers and composites described in this disclosure may be useful as materials in stretchable electric conductors. The good conductivity that is retained upon twisting and bending makes them very useful for devices that employ or could employ such conductors. There can be mentioned as examples for such devices: flexible displays, skin sensors on moving body parts, stretchable circuits, wearable electronic on functional clothes and pressure gauges etc. Lignin can be used as the base material of the fibers which is inexpensive and abundant.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1.-25. (canceled)

26. A stretchable, conductive fibrous mesh/elastomer composite material comprising a mesh of conductive carbonaceous fibers comprising a carbonaceous material obtained from carbonizing an electrospun fiber
wherein said electrospun fiber is derived from lignin and comprises at least one metal precursor, and
wherein said mesh is integrated into an elastomer matrix.

27. The composite material according to claim 26, wherein the metal precursor is converted to a conductive metal particle.

28. The composite material according to claim 26, wherein the metal precursor is selected from the group consisting of a copper and nickel salt.

29. The composite material according to claim 26, wherein the lignin is selected from the group consisting of organosolv lignin, softwood kraft lignin, hardwood kraft lignin and lignosulfonate.

30. The composite material according to claim 26, wherein the precursor partly or fully converts to a corresponding conductive metal nanoparticle via pre-oxidation and reduction during a stabilization and carbonization process.

31. A process for making a stretchable, conductive fibrous mesh/elastomer composite material comprising a mesh of conductive carbonaceous fibers comprising a carbonaceous material obtained from carbonizing an electrospun fiber wherein said electrospun fiber is derived from lignin and comprises at least one metal precurson, and wherein said mesh is integrated into an elastomer matrix, comprising the operations of
a) dispersing the conductive metal precursor into a spinning composition;
b) electrospinning of the obtained composition;
c) carbonizing the obtained fiber to fully or partially convert the metal precursor to conductive metal nanoparticles;
d) putting a layer of a fibrous mesh of the obtained fiber on top of a layer of elastomer wherein said elastomer layer is optionally supported by a substrate;
e) casting a layer of fully or partially uncured elastomer on top of the fibrous mesh optionally supported by degassing in a vacuum; and
f) curing the top elastomer layer.

32. The process according to claim 31 wherein the spinning composition comprises the lignin in admixture with at least one other polymer in a polar solvent.

33. The process according to claim 31 wherein the carbonization step comprises a stabilization as pre-operation.

34. The process according to claim 33 wherein the stabilization pre-operation comprises heat treating the electrospun fibers in an inert atmosphere optionally supported by annealing steps.

35. The composite material according to claim 26 wherein the elastomer is selected from one or more polysiloxanes, polyurethanes, rubbers or a combination thereof.

36. The composite material according to claim 35 wherein the mesh is formed to a layer which is integrated in an elastomer layer.

37. The composite material according to claim 36 wherein the thickness of the integrated composite layer is about 0.1 to 10 mm.

38. The process according to claim 31, wherein the elastomer is pre-stretched in operation d) when putting the fibrous mesh on top of the elastomer.

39. A stretchable electrical conductor comprising a stretchable, conductive fibrous mesh/elastomer composite material comprising a mesh of conductive carbonaceous fibers comprising a carbonaceous material obtained from carbonizing an electrospun fiber wherein said electrospun fiber is derived from lignin and comprises at least one metal precurson, and wherein said mesh is integrated into an elastomer matrix.
